(19) United States
(12) Patent Application Publication
(10) Pub. No.: US 2009/0136221 A1
(43) Pub. Date: May 28, 2009

(54) PHOTOGRAPHIC MANAGEMENT SYSTEM, PHOTOGRAPHIC MANAGEMENT METHOD, AND DEVICE AND PROGRAM USED FOR THEM

(75) Inventor: Nobutatsu Nakamura, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/295,361

(22) PCT Filed: Mar. 27, 2007
(86) PCT No.: PCT/JP2007/056401

§ 371 Date: Sep. 30, 2008

(30) Foreign Application Priority Data
Mar. 30, 2006 (JP) 2006-095361

(51) Int. Cl. G03B 15/00

(52) U.S. Cl. 396/1

(57) ABSTRACT

When a photographer takes a picture of a photographed person (object) who holds his or her own terminal device, the photographer generates photographing information including his or her personal information, photographing conditions, or the like, by a photographic information generating unit (11). A photographic information transmitting unit (13) starts communication for transmission of the generated photographing information. When the communication starts, the photographic information transmitting unit (13) transmits a part or all of the photographer's information to the photographed person's terminal device (2). When a photographing information receiving unit (21) of the photographed person's terminal device (2) receives the photographing information, the information is provided to the photographed person who can confirm that he himself or she herself is about to be photographed or how he or she is going to be photographed.

### APPLICABLE FIELD IN THE INDUSTRY

The present invention relates to a photographing management system, a photographing management method, and a device and a program used for them, and more particularly to a photographing management system, a photographing management method, and a device and a program used for them that enable a photographee being photographed to confirm that he/her is going to be photographed.

### BACKGROUND ART

In recent years, an infringement action upon a personal privacy and a portrait right has become a subject of discussion as a camera that easily can obtain photographing images having a high image quality prevails.

Thereupon, so as to put a limit to photographing in some cases, and to cause conditions for photographing to be known before photographing for a purpose of protecting a personal privacy and a portrait right, the technology has been proposed of causing an object to hold a terminal transmitting information relating to the object, and allowing a camera etc. to read off the information (Patent document 1).

In this technology, an object photographable by the camera is provided with an information transmitter for transmitting information relating to the above object, and the camera is provided with a communicating means for making communication with a photographing management server, an information acquiring means for acquiring the transmission information from the information transmitter, and a photographing controlling means for controlling the photographing by the camera based upon contents of the information acquired by the above information acquiring means and photographing management server.

With this, at the moment of photographing the object provided with the information transmitter with a camera, the information acquiring means that its camera includes acquires transmission information from the information transmitter, thereby enabling the photographing controlling means to control the photographing by its camera based upon the information acquired from its information acquiring means, or the information from the photographing management server that can communicate information with its camera. For example, when, at the moment of photographing an object with a camera, the information saying the effect that its object is inhibited from being photographed is included in the transmission information acquired from the information transmitter that its object includes, the photographing controlling means mounted into its camera forcibly restricts the photographing of its object, thereby making it possible to prevent unauthorized photographing.

Patent document 1: JP-P2005-223602A

### DISCLOSURE OF THE INVENTION

### Problems to be Solved by the Invention

However, the technology of the Patent document 1 is for one-directionally transmitting the information to a photographer from a photographee. That is, the thing, of which the photographing has been permitted results being photographed in a situation the side being photographed does not know that it is photographed.

Further, when, in particular, the thing of which the photographing has been permitted is a person, as a rule, the above person would like to know how he/her is photographed.

Thereupon, the present invention has been accomplished in consideration of the above-mentioned problems, and an object thereof is to provide a technology for enabling the photographee to know photographing information relating to the photographing prior to photographing, or storing of a photographing data.

Further, an object of the present invention is to provide a technology capable of managing photographing images based upon the photographing information.

### Means to Solve the Problem

The 1st invention for solving the above-mentioned problems, which is a photographing management system, characterized in that: said photographing management system comprises a photographer terminal being held by a photographer, and a photographee terminal being held by a photographee or an object; said photographer terminal comprises: a photographing information generating means for generating photographing information relating to photographing of the photographee or the object; and a photographing information transmitting means for transmitting said photographing information to said photographee terminal; and said photographee terminal comprises: a photographing information receiving means for receiving said photographing information; and a presenting means for presenting said received photographing information.

The 2nd invention for solving the above-mentioned problems, in the above-mentioned 1st invention, is characterized in that: said photographee terminal comprises a photographee information transmitting means for transmitting photographee information relating to the photographee or the object to the photographer terminal; and said photographer terminal comprises: a means for receiving said photographee information; a presenting means for presenting said received photographee information; a changing means for changing said photographing information; and a photographing information storing means for storing said changed photographing information.

The 3rd invention for solving the above-mentioned problems, in the above-mentioned 1st or 2nd inventions, is characterized in comprising a charge money managing means for managing charge money for photographing based upon said photographing information.

The 4th invention for solving the above-mentioned problems, in one of the above-mentioned 1st to 3rd inventions, is characterized in comprising a limit managing means for managing a limit to exhibition or utilization of a photographing image based upon said photographing information or said photographee information.

The 5th invention for solving the above-mentioned problems, in the above-mentioned 4th invention, is characterized in that said limit managing means is configured to charge money based upon the utilization of the photographing image.

The 6th invention for solving the above-mentioned problems, which is an image management system, characterized in comprising a photographing image utilization managing means for, based upon photographing information prepared at a moment of photographing, managing a utilization situation of a photographing image that corresponds to said photographing information, and charging money based upon the utilization situation of the photographing image.

The 7th invention for solving the above-mentioned problems, which is a photographing terminal, characterized in comprising: a photographing information generating means for generating photographing information relating to photographing of an object; and a photographing information transmitting means for transmitting said photographing information to a terminal of a photographee.

The 8th invention for solving the above-mentioned problems, in the above-mentioned 7th invention, is characterized in comprising: a means for receiving photographee information relating to a photographee or an object, which is transmitted; a presenting means for presenting said received photographee information; a changing means for changing said photographing information; and a photographing information storing means for storing said changed photographing information.

The 9th invention for solving the above-mentioned problems, in the above-mentioned 7th or 8th inventions, is characterized in comprising a means for transmitting said photographing information to a server connected to a network.

The 10th invention for solving the above-mentioned problems, which is a photographee terminal, characterized in comprising: a photographing information receiving means for receiving photographing information relating to photographing of an photographee or an object, which is transmitted by a photographer; and a presenting means for presenting said received photographing information.

The 11th invention for solving the above-mentioned problems, which is an image management server, characterized in comprising a photographing image utilization managing means for, based upon photographing information prepared at a moment of photographing, managing a utilization situation of a photographing image that corresponds to said photographing information, and charging money based upon the utilization situation of the photographing image.

The 12th invention for solving the above-mentioned problems, which is a photographing management method, characterized in comprising: a process in which a terminal of a photographer generates photographing information relating to photographing of a photographee or an object, and transmits this photographing information to a terminal of the photographee; and a process in which said terminal of said photographee receives said photographing information, and confirms said received photographing information.

The 13th invention for solving the above-mentioned problems, in the above-mentioned 12th invention, is characterized in comprising: a process in which said terminal of said photographee transmits photographee information relating to the photographee or the object to said terminal of said photographer; and a process in which said terminal of said photographer receives said photographee information, changes the photographing information changed based upon said photographee information, and stores the changed photographing information.

The 14th invention for solving the above-mentioned problems, which is a photographing management program, characterized in causing an information processing of device to execute the processes: generating photographing information relating to photographing of an object; and transmitting said photographing information to a terminal of a photographee.

The 15th invention for solving the above-mentioned problems, in the above-mentioned 14th invention, is characterized in causing the information processing device to execute the processes of: receiving photographee information relating to a photographee or an object, which is transmitted; presenting said received photographee information; changing the photographing information changed based upon said photographee information; and storing said changed photographing information.

The 16th invention for solving the above-mentioned problems, in the above-mentioned 14th or 15th inventions, is characterized in causing the information processing device to execute a process of transmitting said photographing information to a server connected to a network.

The 17th invention for solving the above-mentioned problems, which is a photographing management program, characterized in causing an information processing device to execute the processes of: receiving photographing information relating to photographing of an photographee or an object, which is transmitted by a photographer; and presenting said received photographing information.

### AN ADVANTAGEOUS EFFECT OF THE INVENTION

In accordance with the present invention, the photographee can confirm that he/her is going to he photographed, and how he/her is going to be photographed, thus enabling he/her to be protected from an infringement action upon privacy and a portrait right.

### BRIEF DESCRIPTION OF THE DRAWINGS

FIG. 1 is a view illustrating a configuration of a first embodiment.

FIG. 2 is an operational flowchart of the first embodiment.

FIG. 3 is a view illustrating a configuration of a second embodiment.

FIG. 4 is a view illustrating a configuration of a third embodiment.

FIG. 5 is a view illustrating another configuration of the third embodiment.

### DESCRIPTION OF NUMERALS

1 photographing device
2 photographee terminal
3 management server
11 photographing information generating unit
12 photographing information storing unit
13 photographing information transmitting unit
14 photographee information receiving unit
15 displaying unit
16 photographing unit
21 photographing information receiving unit
22 photographee information transmitting unit
23 displaying unit

### BEST MODE FOR CARRYING OUT THE INVENTION

A first embodiment of the present invention will be explained.

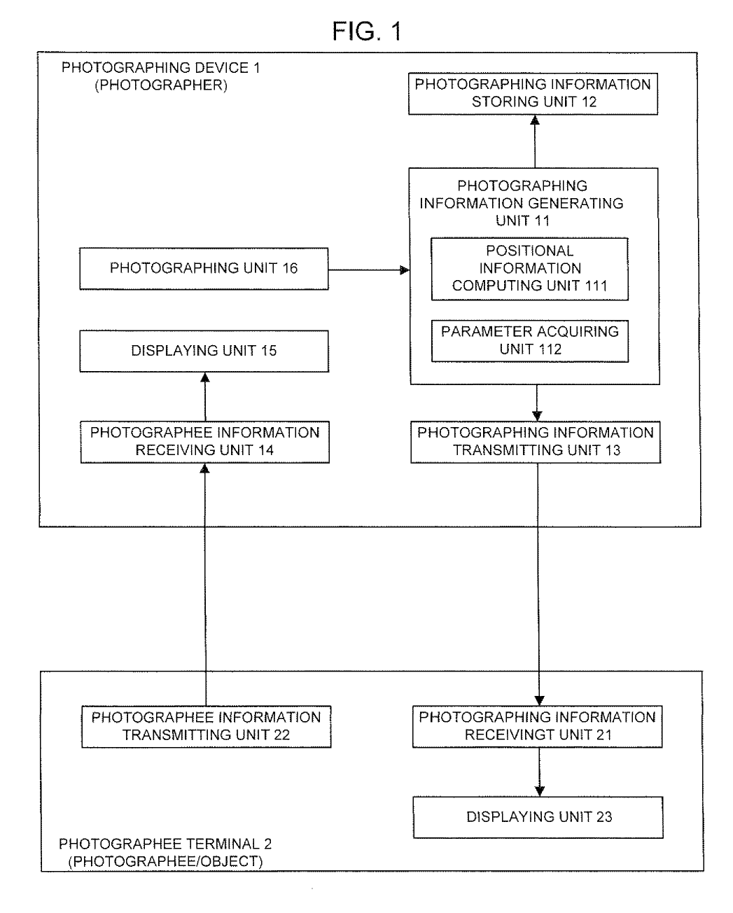

FIG. 1 is a view in which a configuration of a photographing management system in the first embodiment has been shown.

As shown in FIG. 1, the photographing management system is configured of a photographing device 1 that a photographer holds, and a photographee terminal 2 that a photographee (object) holds. Additionally, with regard to the photographee (object), any thing is acceptable, for example, a person, a movable property, and a real property so long as it is photographable.

At first, a configuration of the photographing device 1 will be explained.

The photographing device 1, which is a camera etc. being typified by a digital camera, includes a photographing information generating unit 11, a photographing information storing unit 12, a photographing information transmitting unit 13, a photographee information receiving unit 14, a displaying unit 15, and a photographing unit 16.

The photographing information generating unit 11 is a means for generating information of the photographer, and photographing information, being information relating to conditions of photographing and a photographing method. Herein, the so-called photographing information is personal information (a name, an age, an address, a position, a communication destination etc.) of the photographer, information of how to pay a photographing fee, positional information (a photographing position viewed from the photographee, etc.), posture information (a direction of a camera, for example, an up-down direction, a left-right direction, a rotation direction, etc.), information relating to a photographing method and a kind of lens (an angle of view, a zoom, a resolution, a shutter speed, a white balance, an exposure, existence of an electronic flash, a use film, etc.), the number of pictures, a photographing time, existence of provision of a sample photographing image or a preview photographing image, and conditions for utilizing photographed photographing images by a third party (permission or non-permission of exhibition of the photographing image to a third party, a utilization fee required for utilizing the photographing image, a limit to delivery of the photographing image, etc.), or the like. The photographing information generating unit 11, for a purpose of generating the information relating to the photographing method, out of these items of the information, includes a position computing unit 111 for acquiring posture information etc. of the photographing device 1, and a parameter acquiring unit 112 for acquiring a photographing parameter from the photographing unit 16. Additionally, the photographing information may be generated at the moment of transmission, or for each photographing, and the personal information such as the photographer, or the like may be pre-registered.

The photographing information storing unit 12, which is a recording unit into which the photographing information generated by the photographing information generating unit 11 is recorded, is a hard disc, a non-volatile memory (a flash memory or an SD card), etc.

The photographing information transmitting unit 13, which is a means for transmitting the photographing information to the photographee terminal 2 being held by the photographee (object), has, for example, a wireless LAN communication function.

The photographee information receiving unit 14, which has, for example, a wireless LAN communication function, is a means for receiving photographee information to be described later, and displaying the photographee information on the displaying unit 15.

The displaying unit 15 is a displaying means such as LCD in which at least the received photographee information is displayed, and is employed for confirming these items of the information.

The photographing unit 16 is configured of a well-known photographing element, an image processor, etc.

Next, a configuration of the photographee terminal 2 will be explained.

The photographee terminal 2, which the photographee (object) holds, includes a photographing information receiving unit 21, a photographee information transmitting unit 22, and a displaying unit 23.

The photographing information receiving unit 21, which has, for example, a wireless LAN communication function, is a means for receiving the photographing information being transmitted from the photographing Information transmitting unit 13 of the photographing device 1.

The photographee information transmitting unit 22, which has, for example, a wireless LAN communication function, is for transmitting photographee information to the photographing device 1. Herein, the so-called photographee information is information of permission of the photographing of the photographee (object), information relating to the photographing of the photographee (object), or the like, and, for example, information of permission or non-permission of the photographing of the photographee (object), personal information (a name, an age, an address, a position, a communication destination etc.) of the photographee (object), positional information (latitude, longitude, time) of the photographee (object), posture information (an angle of each joint having a plurality of sensors) of the photographee (object), information of a fashion data (a commodity name, a brand, and a shop name of the object, and names of clothes, a bag, and accessories that the photographee is wearing), a three-dimensional shape of the photographee (object), a face data, an alternative image in the case of prohibiting the photographing, and an encryption key for encrypting the photographed image, information relating a limit to exhibition of the photographing image (information of non-permission of the photographing, non-permission of exhibition notwithstanding permission of the photographing, or the like), information of a photographing fee, a portrait right fee, how to pay/receive the photographing fee, a camera position and a camera direction in which the photographing is permitted (an up-down direction (for example, a limit of ±30 degree with a horizontal direction assumed to be angle 0 degree), a left-right direction (for example, a limit of ±100 degree with a frontal direction assumed to be angle 0 degree), a rotation direction (for example, no limit)), a camera parameter (an angle of view (for example, size of the object in a video and a limit to precision), a zoom (for example, a limit to a partial zoom), a photographing resolution, a shutter speed, a white balance, an exposure, existence of an electronic flash, a use film), the number of pictures being permitted and a photographing time, or the like. Additionally, all of these items of information do not need be included in the photographee information, and for example, the photographee information may be generated, in a format for responding to the transmitted photographing information, for example, in such a format that permission or non-permission of the photographing condition being requested can be grasped, thereby to transmit it to the photographing device 1.

The displaying unit 23, which is a display means such as LCD, is employed for confirming the received photographing Information.

Next, an operation of the photographing management system configured as described above will be explained.

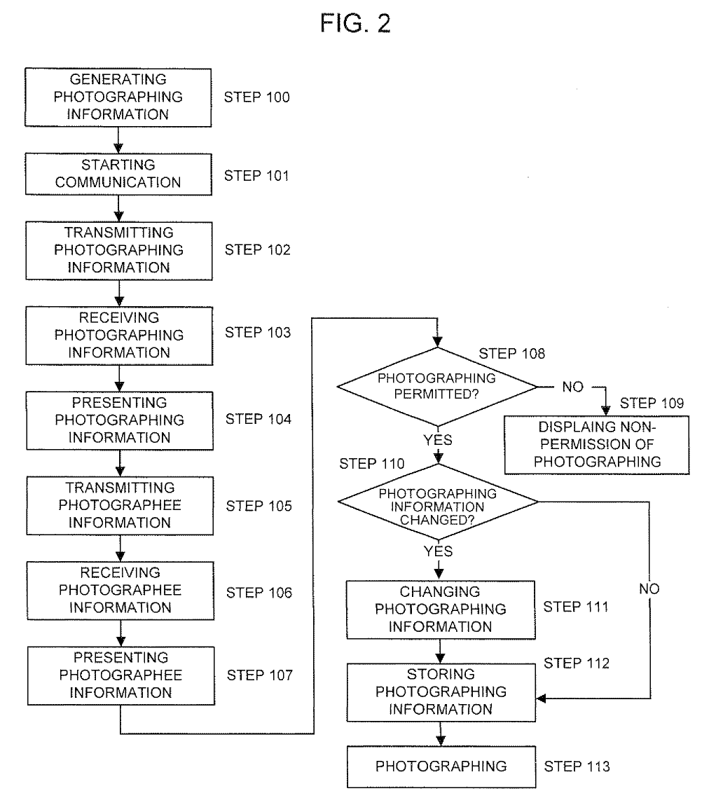

FIG. 2 is an operational flowchart of the photographing management system in the first embodiment.

At first, it is assumed that the photographing information receiving unit 21 of the photographee terminal 2 of the photographee, which has ESSID (Extended Service Set Identifier)=“PhotoRestricted” set therein, is in a status of waiting for connection.

Herein, when a certain photographer photographs the photographee (object) holding the photographee terminal, the photographer causes the photographing information generating unit 11 to generate the photographing information including personal information of the photographer and the photographing conditions (Step 100).

The photographing information transmitting unit 13 finds out a wireless LAN access point of SSID=“PhotoRestricted” for a purpose of transmitting the generated photographing information. And, when having found out the wireless LAN access point of SSID=“PhotoRestricted”, the photographing information transmitting unit 13 makes a network connection to a wireless LAN, and starts communication (step 101). Additionally, at the moment of communication, BSSID (Basic Service Set Identifier) and an ESS-ID Stealth may be employed instead of the foregoing ESSID in some cases, and by setting an encryption key (WEP, WPA, WPA2, certificate) to the wireless LAN, the connection itself may be restricted in some cases.

The photographing information transmitting unit 13, when the communication is started, transmits one part or all of the photographing information to the photographee terminal 2 (step 102).

When the photographing information receiving unit 21 of the photographee terminal 2 of the photographee receives the photographing information (step 103), it presents the photographing information to the photographee (step 104), thereby enabling the photographee to confirm that he/her is going to be photographed, and how he/her is going to be photographed, and enabling he/her to be protected from an infringement action upon the privacy and the portrait right.

Next, the photographee transmits the photographee information, being information relating to permission of the photographing or non-permission of the photographing, designation of photographing conditions, a payment of the photographing fee in the case of permitting the photographing, or the like, to the photographing device 1 of the photographer by employing the photographee terminal 2 (step 105).

The photographee Information receiving unit 14 of the photographing device 1 of the photographer receives the photographee information (step 106), and presents the received photographee information to the photographer (step 107).

The photographer, based upon the presented photographee information, can know information as to whether the photographing has been permitted, or whether the photographing is permitted only under a predetermined condition even though the photographing has been permitted. At this moment, when the number of photographing targets is plural, and the photographing of one part thereof is not permitted, the position of the photographee of which the photographing is not permitted may be superposedly displayed on a liquid crystal screen with a framework attached by using the positional information of the photographer. Further, the above position may be shown clearly by use of the means for changing brightness of the liquid crystal only for a non-permission matter, the means for displaying the non-permission matter with a gray scale, or the like.

When the presented photographee information is information of non-permission of the photographing (step 108), the display of non-permission of the photographing is made. Further, a warning means may be provided in the photographing device 1, thereby to issue a warning based upon the photographee information when the photographing is not permitted.

On the other hand, when the presented information is information of partial non-permission of the photographing (step 110), the photographing conditions etc. are changed so as to meet the presented photographing conditions (step 111), and when information necessary for managing the photographing image, for example, charge money information, information relating to management of the portrait right, or the like is included in the acquired photographee information, the photographing information including these items of the information is stored in the photographing information storing unit 12 (step 112). Additionally, the photographing information being stored may be transmitted to the photographee terminal 2 again for conformation.

When the photographing information is stored, the photographer takes the photographing (step 113). At this time, when the photographing information does not meet all of the presented photographing conditions, the photographing unit 16 may be locked so that the photographing cannot be taken. Further, one part or all of the photographing information may be stored in a format such as EXIF together with the photographing image. In addition hereto, by replacing the part of which the photographing is not permitted with the alternative image being presented by a non-photographer, it is also possible to obtain the image that has steered clear of involvement in the problem of a portrait right.

Upon explaining the foregoing operation by a specific example, when a certain photographer photographs the photographee (object) holding the photographee terminal, the photographer causes the photographing information generating unit 11 to generate the photographing information. Herein, it is assumed that the generated photographing information Includes “Photographer: AA taro”, “Address: the City of Tokyo˜”, “Photographing method: photographing at a front”, “Photographing fee: free”, “Limit to utilization: none”.

The photographing information transmitting unit 13, for a purpose of transmitting the generated photographing information, starts communication, and transmits the photographer information to the photographee terminal 2.

When the photographing information receiving unit 21 of the photographee terminal 2 of the photographee receives the photographing information, “Photographer: AA tare”, “Address: the City of Tokyo˜”, “Photographing method: photographing at a front”, “Photographing fee: free”, and “Limit to utilization: none”, each of which is photographing information, are presented. This information enables the photographee to confirm that he/her is going to be photographed by “Photographer: AA taro”, and that he/her is going to be photographed at a front.

Next, the photographee transmits the photographee information, being information relating to permission of the photographing or non-permission of the photographing, designation of the photographing conditions and a payment of the photographing fee, or the like in the case of permitting the photographing, to the photographing device 1 of the photographer by employing the photographee terminal 2. Herein, the photographee transmits, “Portrait right ID: 123”, “Permission of the photographing” “Photographing fee: 1,000 yen”, “Payee: A bank”, “Permission of perusal by a third party”, and “prohibition of re-utilization by a third party”, each of which is previously prepared photographee information.

The photographee information receiving unit 14 of the photographing device 1 of the photographer receives photographee information, and presents the received photographee information to the photographer. In this example, “Portrait right ID: 123”, “Permission of the photographing”, “Photographing fee: 1,000 yen”, “Payee: A bank”, “Permission of perusal by a third party”, and “Prohibition of re-utilization by a third party”, each of which is photographee information, are displayed.

The photographer changes the photographing condition so as to meet the photographing conditions based upon the presented photographee information. The changed photographing information becomes “Photographer: AA taro”, “Address: the City of Tokyo˜”, “Photographing method: photographing at a front”, “Portrait right ID: 123”, “Permission of the photographing”, “Photographing fee: 1,000 yen”, “Payee: A bank”, “Permission of perusal by a third party”, and “Prohibition of re-utilization by a third party”, and this photographing information is stored in the photographing information storing unit 12. Additionally, the photographing information being stored may be transmitted again to the photographee terminal 2 for confirmation.

When the photographing information is stored, the photographer takes the photographing based upon the photographing information. At this time, information similar to the photographing information stored in the photographing information storing unit 12 may be added to the photographing image for storing.

In such a manner, in the photographing management system in this embodiment, the photographee (object) being photographed can confirm that he/her is going to be photographed, and how he/her is going to be photographed because he/her is notified of the photographing information prior to the photographing. Further, the photographing information being notified to the photographee, which also includes the personal information of the photographer, the photographing method, etc., also can be put to practical use for managing the portrait right, charging the photographing fee or the like.

Additionally, in the foregoing embodiment, the photographing device 1 was configured to include the photographing information generating unit 11, the photographing information storing unit 12, the photographing information transmitting unit 13, the photographee information receiving unit 14, and the displaying unit 15; however the terminal that is configured of one part or all of them may be provided separately from the photographing device 1.

Further, in the foregoing embodiment, the communication between the photographing device 1 and the photographee terminal 2 was realized by employing the wireless LAN communication function, and is not limited hereto. For example, the photographing information transmitting unit 13 and the photographee information transmitting unit 22 may be configured by employing RFID. Further, a configuration may be made so that a mark (a two-dimensional code, a bar code, and a character string) is affixed to the photographee, the photographing device 1 side reads off it, and detects a telephone number being included in its mark, and the photographing device of the photographer makes a connection to a designated telephone number, and transmits the photographing information.

Further, a configuration may be made so that one part or all of the photographing information and the photographee information is temporally stored in an external server, and thereafter the photographing information and the photographee information are downloaded from the server for perusal. In the configuration of this case, the information that is transmitted from the photographing device of the photographer to the photographee terminal of the photographee, or from the photographee terminal of the photographee to the photographing device of the photographer includes identification information for identifying the photographer or the photographee, and with this identification information, an access to the server is made.

In addition hereto, the photographee may provide only the condition that he/her cannot accept, out of the desired conditions of the photographing information acquired from the photographer, as photographee information.

A second embodiment will be explained.

The second embodiment is characterized in that a management server for managing the photographing fee is provided in addition to a configuration of the first embodiment.

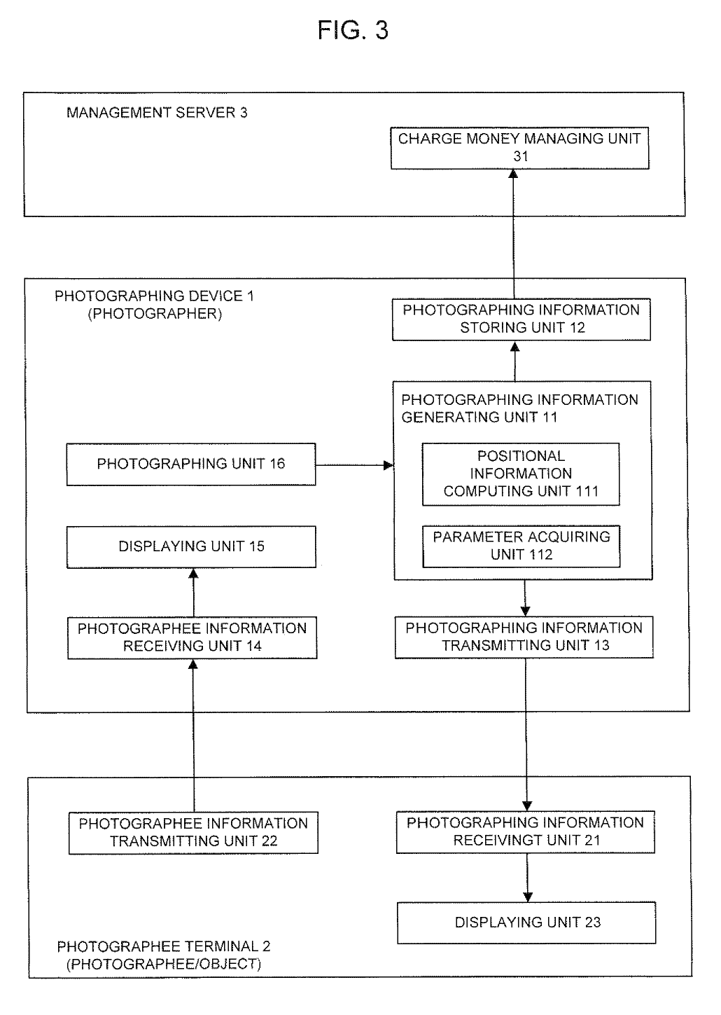

FIG. 3 is a block diagram illustrating a configuration of the second embodiment.

As shown in FIG. 3, the photographing management system of the second embodiment includes a management server 3 for managing the photographing fee in addition to a configuration of the first embodiment. This management server 3 includes a charge money managing unit 31 for acquiring photographing information of the photographing device 1 and managing charge money based upon this photographing information.

The photographing device 1, which has a transmitting/receiving function of making communication with the managing server, transmits the photographing information stored in the photographing information storing unit 12 to the management server 3. Additionally, the photographing device 1 does not need to have a communication function necessarily, and may upload the stored photographing information to the management server 3 by use of other communication means.

The charge money managing unit 31 acquires photographing information from the photographing device 1, makes a reference to the charge money information and the information relating to the portrait right that are included in this photographing information, and manages the charge money. As a method of charging money, a credit card, an electronic money, a bank transfer, an escrow system, a carrier system, clearing by an ISP enterpriser as an agent, or the like is thinkable.

A third embodiment will be explained.

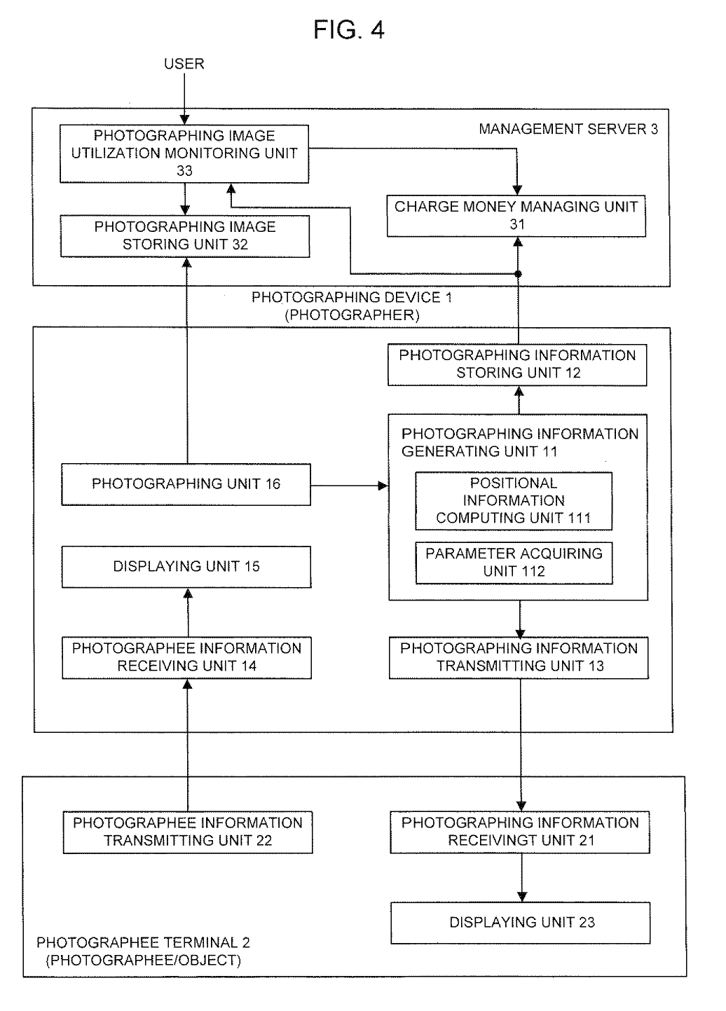

FIG. 4 is a configuration view of the management system of the third embodiment.

The photographing management system of the third embodiment, in addition to a configuration of the second embodiment, includes a management server 3 that includes a photographing image storing unit 32 for storing the photographing image, and a utilization monitoring unit 33 for monitoring a utilization situation of the photographing image.

The photographing image storing unit 32, in which the photographing image photographed by the photographing device 1 is stored, transmits the stored photographing image to a user having made an access from the outside via the utilization monitoring unit 33. In this embodiment, the photographing device 1 is configured to have a transmitting/receiving function of making communication with the managing server and to transmit the photographing image stored in the photographing unit 16 to the management server 3; however the method of storing the photographing image is not limited hereto, and the photographing device 1 does not need to have a communication function necessarily, and may upload the stored photographing image to the management server 3 by use of other communication means.

The utilization monitoring unit 33 is for monitoring the access, which aims at perusing or utilizing the photographing image stored in the photographing image storing unit 32, and presenting utilization conditions of its photographing image to an accessor prior to the perusal and the utilization.

Herein, the so-called utilization condition is a perusal fee of the photographing image, a fee required for utilizing the photographing image (for example, re-utilization accompanied by downloading the photographing image) and its term of validity, a limit to delivery of the photographing image, or the like. These conditions are decided based upon the photographing information being transmitted from the photographing device 1. The photographing information, as described above, includes not only the photographing method such as a camera parameter, but also the condition for utilizing the photographed photographing image by a third party (permission or non-permission of exhibition of the photographing image to a third party, a utilization fee required for utilizing the photographing image, a limit to delivery of the photographing image, etc.). The utilization condition for a third party is a condition into which the utilization condition being included in the photographee information has been reflected, and as a result, the utilization condition as well being presented to an accessor is a condition into which the conditions of both of the photographer and the photographee have been reflected.

In such a manner, when the utilization condition is presented to a user, and the user accepts it, the utilization fee is cleared off in the charge money managing unit 31. As a payment method, a credit card, an electronic money, a bank transfer, an escrow system, a carrier system, clearing by an ISP enterpriser as an agent, or the like is thinkable. Additionally, when the condition that the photographer (for example, a copyright use fee) and the photographee (a portrait right fee) are included in the utilization fee exists in the photographing information, the process of collecting a bill in which the user directly pays the copyright use fee to the photographer, and the photographer delivers the portrait right fee to the photographee is thinkable, whereas there exists the process also in which the management server 3 collects the utilization fee for a time being, distributes the copyright fee and the portrait right fee to the photographer and the photographee, respectively, and a server enterpriser gets a commission fee.

Further, when the photographee information is adapted to include a data of a commodity such as clothes being included in the image, and an image user procures a commodity with the above commodity data as a turning point, it is thinkable that a commodity-selling agent pays a reward to the photographer and the photographee. There exists the process as well in which the management server 3 traces a procurement action of the user, and collects the reward fee from the commodity selling agent, distributes money equivalent to the copyright fee and money equivalent to the portrait right fee to the photographer and the photographee, respectively, and a server enterpriser gets a commission fee.

Further, a configuration may be made so that a photographing image being stored in the photographing image storing unit 32 is pre-encrypted, and after the charge money managing unit 31 confirms receipt of money from the user, the utilization monitoring unit 33 transmits a decoding key of its photographing image.

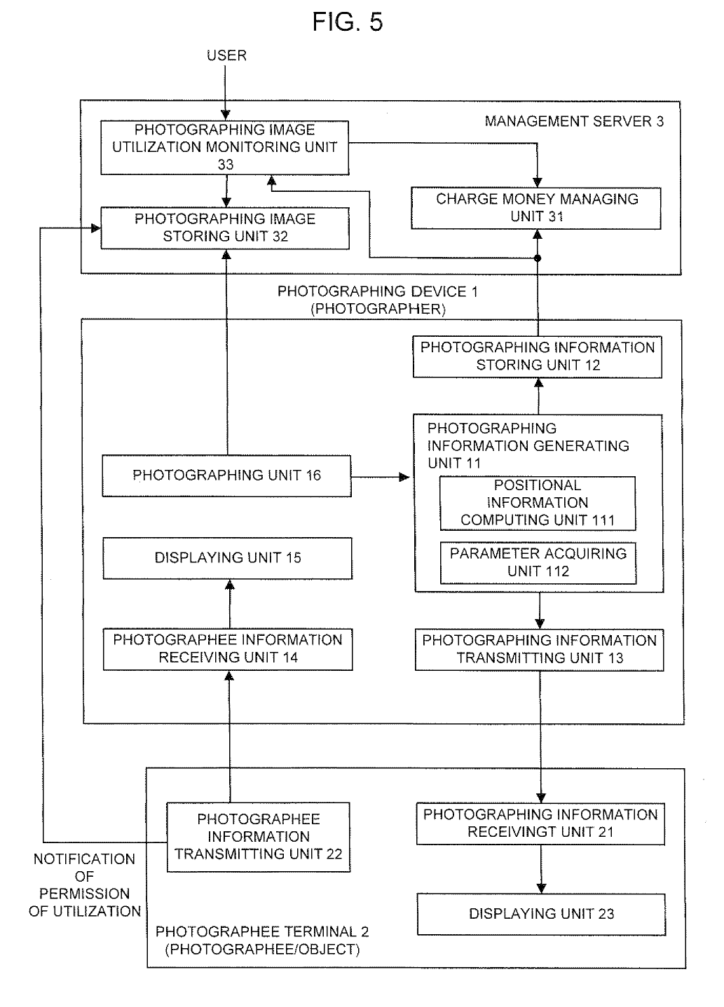

In addition hereto, as shown in FIG. 5, a notification of utilization permission from the photographee information transmitting section 22 of the photographee terminal 2 is previously stored in the photographing image storing unit 32 together with the photographing image, and by preventing the photographing image of which the utilization permission has not been notified from being utilized, it is also possible to protect the photographee all the more.

1-17. (canceled)

18. A photographing management system, characterized in that:
said photographing management system comprises a photographer terminal being held by a photographer, and a photographee terminal being held by a photographee or an object;
said photographer terminal comprises:
a photographing information generating means for generating photographing information relating to photographing of the photographee or the object;
a photographing information transmitting means for transmitting said photographing information to said photographee terminal;
a means for receiving photographee information relating to said photographee or said object;
a presenting means for presenting said received photographee information;
a changing means for changing said photographing information based upon said received photographee information; and
a photographing information storing means for storing said changed photographing information; and
said photographee terminal comprises:
a photographing information receiving means for receiving said photographing information;
a presenting means for presenting said received photographing information; and
a photographee information transmitting means for transmitting said photographee information to said photographer terminal.

19. A photographing management system according to claim 18, characterized in that:
said photographing management system comprises an image management apparatus for providing a service for perusing/utilizing a photographing image; and
said image management apparatus comprises:
a means for presenting utilization conditions of the photographing image to an accessor, being a person who is going to peruse/utilize the photographing image; and
a limit managing means for managing a limit to exhibition or utilization of the photographing image based upon said utilization conditions.

20. A photographing management system according to claim 19, characterized in that said limit managing means is configured to mediate and manage giving/receiving of a fee based upon the utilization of the photographing image between the image peruser/utilizer and each of the photographer and the photographee.

21. A photographing management system according to claim 19, characterized in that said limit managing means is configured to charge money according to a use of managing a limit to exhibition or utilization of the photographing image based upon information of payment of a fee by the image peruser/utilizer.

22. An image management system, characterized in comprising a photographing image utilization managing means for, based upon photographing information prepared at a moment of photographing, managing a utilization situation of a photographing image that corresponds to said photographing information, and charging money based upon the utilization situation of the photographing image.

23. A photographing terminal for presenting photographing information relating to photographing of an object to a photographee terminal being held by a photographee or an object, characterized in comprising:
a photographing information generating means for generating photographing information relating to photographing of the object;
a photographing information transmitting means for transmitting said photographing information to the terminal of the photographee;
a means for receiving photographee information relating to the photographee or the object, which is transmitted;
a presenting means for presenting said received photographee information;
a changing means for changing said photographing information based upon said received photographee information; and
a photographing information storing means for storing said changed photographing information.

24. A photographing terminal according to claim 23, characterized in comprising a means for transmitting said photographing information to a server connected to a network.

25. A photographee terminal, characterized in comprising:
a photographing information receiving means for receiving photographing information relating to photographing of a photographee or art object, which is transmitted by a photographer;
a presenting means for presenting said received photographing information; and
a photographee information transmitting means for transmitting photographee information relating to the photographee or the object to a photographer terminal of said photographer.

26. An image management server, characterized in comprising a photographing image utilization managing means for, based upon photographing information prepared at a moment of photographing, managing a utilization situation of a photographing image that corresponds to said photographing information, and charging money based upon the utilization situation of the photographing image.

27. A photographing management method, characterized in comprising:
a process in which a terminal of a photographer generates photographing information relating to photographing of a photographee or an object, and transmits this photographing information to a terminal of the photographee;
a process in which said terminal of said photographee receives said photographing information, and confirms said received photographing information;
a process in which said terminal of said photographee transmits photographee information relating to the photographee or the object to said terminal of said photographer; and
a process in which said terminal of said photographer receives said photographee information, changes the photographing information changed based upon said photographee information, and stores the changed photographing information.

28. A photographing management program for presenting photographing information relating to photographing of an object to a photographee terminal being held by a photographee or an object, characterized in causing an information processing device to execute the processes of:
generating photographing information relating to photographing of the object;
transmitting said photographing information to the terminal of the photographee;
receiving photographee information relating to the photographee or the object, which is transmitted;
presenting said received photographee information;
changing the photographing information changed based upon said photographee information; and
storing said changed photographing information.

29. A photographing management program according to claim 28, characterized in causing the information processing device to execute a process of transmitting said photographing information to a server connected to a network.

30. A photographing management program, characterized in causing an information processing device to execute the processes of:
receiving photographing information relating to photographing of a photographee or an object, which is transmitted by a photographer;
presenting said received photographing information; and
transmitting photographee information relating to the photographee or the object to a photographer terminal.

31. A photographing management system according to claim 20, characterized in that said limit managing means is configured to charge money according to a use of managing a limit to exhibition or utilization of the photographing image based upon information of payment of a fee by the image peruser/utilizer.
